(19) United States
(12) Patent Application Publication
(10) Pub. No.: US 2008/0048577 A1
(43) Pub. Date: Feb. 28, 2008

(54) Projector HID lam ballast having LLC resonant converter

(76) Inventor: Matthew Beasley, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/467,541

(22) Filed: Aug. 26, 2006

(51) Int. Cl. H05B 39/04

(52) U.S. Cl. 315/209 R

(57) ABSTRACT

A ballast for a projector high-intensity discharge (HID) lamp includes an electrical connector and an inductor-inductor-capacitor (LLC) resonant converter. The electrical connector is receptive to electrical coupling with the projector HID lamp. The LLC resonant converter is to convert and transmit power received from a power source to the projector HID lamp via the electrical connector.

### BACKGROUND

Projectors are devices that are commonly connected to computing devices or other devices that are capable of outputting image data, such as personal computers (PC's), digital versatile disc (DVD) players and other types of audio/visual (AV) equipment, and which display the image data for viewing purposes. A projector includes a light source, such as a lamp. One type of projector lamp is a high-intensity discharge (HID) lamp, such as a noble gas HID lamp. An issue with such projector HID lamps is that as they age, the HID lamps require higher operating voltages after aging to output substantially the same amount of light as compared to when the HID lamps are new.

### BRIEF DESCRIPTION OF THE DRAWINGS

FIG. 1 is a rudimentary diagram of a representative projector having a high-intensity discharge (HID) lamp and a corresponding ballast, according to an embodiment of the invention.

FIG. 2 is a diagram of a ballast for a projector HID lamp and that has an inductor-inductor-capacitor (LLC) resonant converter, according to an embodiment of the invention.

FIG. 3 is a diagram of an LLC resonant converter for a projector HID lamp ballast, according to an embodiment of the invention.

FIG. 4 is a flowchart of a method for operating a ballast having an LLC resonant converter to ignite and then maintain constant power to a projector HID lamp, according to an embodiment of the invention.

### DETAILED DESCRIPTION OF THE DRAWINGS

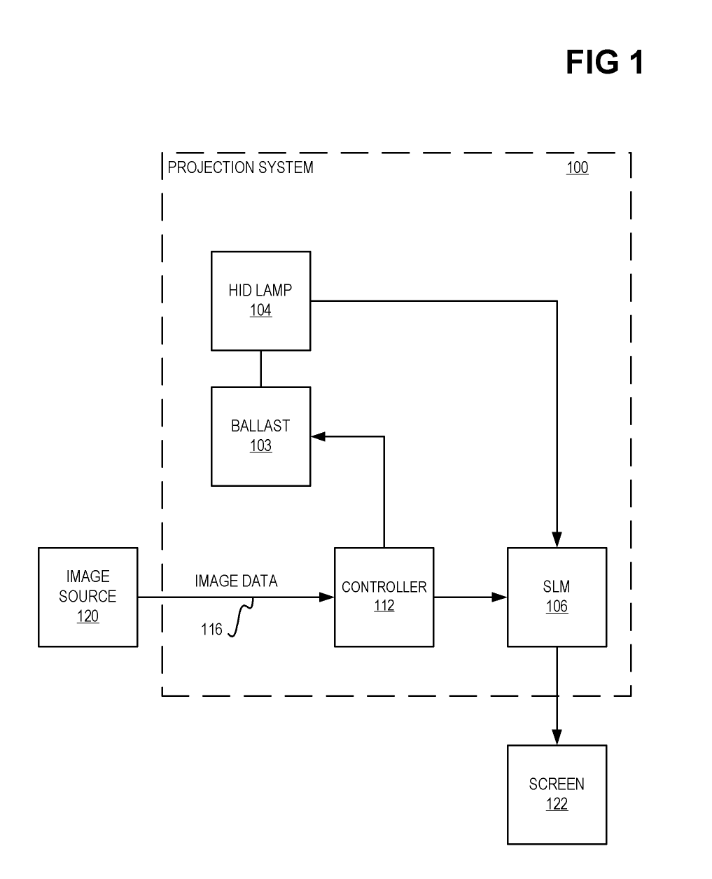

FIG. 1 shows a representative projection system 100 according to an embodiment of the invention. The system 100 may be implemented as a projector. As can be appreciated by those of ordinary skill within the art, the system 100 includes components specific to a particular embodiment of the invention, but may include other components in addition to or in lieu of the components depicted in FIG. 1. The projection system 100 includes a high-intensity discharge (HID) lamp 104, a ballast 103 for the HID lamp 104, a spatial light modulator 106, a controller 112 operatively or otherwise coupled to an image source 120 to receive image data 116, as well as a screen 122.

The HID lamp 104 outputs light, and is controlled by the ballast 103. The ballast 103 is an electrical component that controls the electrical power provided to the HID lamp 104 for operational purposes. The HID lamp 104 operates by establishing an arc between two electrodes within a gas-filled tube, which causes a gas to produce visible radiant energy. The electrodes of a projector HID lamp are typically separated by a very short distance, measured in millimeters, and the gas in the tube is very highly pressurized, allowing the arc to generate extremely high temperatures and causing a portion of the gas to become a plasma and release large amounts of visible radiant energy. In one embodiment, the gas of the HID lamp 104 is a noble gas, such as, but not limited to, xenon and argon.

Projector HID lamps differ from HID lamps used in other applications, such as automotive headlamp applications, in that projector HID lamps are much more highly pressurized, and have electrode gaps that are significantly smaller. As a result, whereas typical HID lamps are ignited at several times their normal operating voltage, and the voltage then decreases to the normal operating voltage, this type of operating methodology is inapplicable to projector HID lamps. A projector HID lamp typically is ignited at a lower voltage, and the voltage then increases to the normal operating voltage as the lamp warms up. Ballasts of the type normally used for HID lamps are not useful for projector HID lamps, because they typically are incapable of producing the lower steady-state operating voltages of the projector HID lamps.

Furthermore, noble gas projector HID lamps differ from other types of projector HID lamps, such as those that employ mercury vapor. In particular, the operating voltages of such noble gas projector HID lamps are generally significantly lower and the operating currents of these noble gas projector HID lamps are generally significantly higher than those of other types of projector HID lamps. As such, conventional ballasts employed for non-noble gas projector HID lamps are not well adapted for use in relation to noble gas projector HID lamps. However, even conventional ballasts for non-noble gas projector HID lamps are disadvantageous in that the wide range of operating voltages of such non-noble gas projector HID lamps can result in the ballasts being relatively large and expensive.

The HID lamp 104 may in one embodiment be detachably connected to the ballast 103. Therefore, the HID lamp 104 may be replaced within the projection system 100 without having to replace the ballast 103, such that the lamp 104 and the ballast 103 are separate components. This can be advantageous, because typically the ballast 103 has a longer lifetime than the HID lamp 104 does. In another embodiment, however, the HID lamp 104 together with the ballast 103 constitutes an integrated lamp-ballast assembly, where the HID lamp 104 is permanently connected to the ballast 103. In this instance, when the HID lamp 104 burns out and/or the ballast 103 becomes non-operational, the assembly including the HID lamp 104 and the ballast 103 is replaced within the system 100, where the assembly as a whole is detachably connected within the system 100.

The light output by the HID lamp 104 is for ultimate modulation by the spatial light modulator (SLM) 106, which may be a digital micromirror device, or another type of SLM. The SLM 106 is more generally considered an image-display component of the projection system 100. The controller 112 controls the SLM 106 in accordance with the image data 116 received from the image source 120, and further controls the ballast 103 to appropriately turn on the HID lamp 104 when the projection system 100 is to display the image data 116. The controller 112 may be implemented in hardware, software, or a combination of hardware and software. The image source 120 may be a computing device, such as a computer, or another type of electronic and/or video device.

The light output by the HID lamp 104 is thus projected onto the SLM 106, and then outwards from the projection system 100, where it is displayed on the screen 122, or another physical object, such as a wall, and so on. The projection system 100 can and typically does include various optics components, such as mirrors, lenses, and so on, between the HID lamp 104 and the SLM 106 and/or between the SLM 106 and the screen 122, which are not depicted in the rudimentary diagram of the projection system in FIG. 1 for illustrative convenience and clarity. The screen 122 itself may be a front screen or a rear screen, such that the projection system 100 may be a front-projection system or a rear-projection system, as can be appreciated by those of ordinary skill within the art. The user of the projection system 100, and other individuals able to see the screen 122, are then able to view the image data 116.

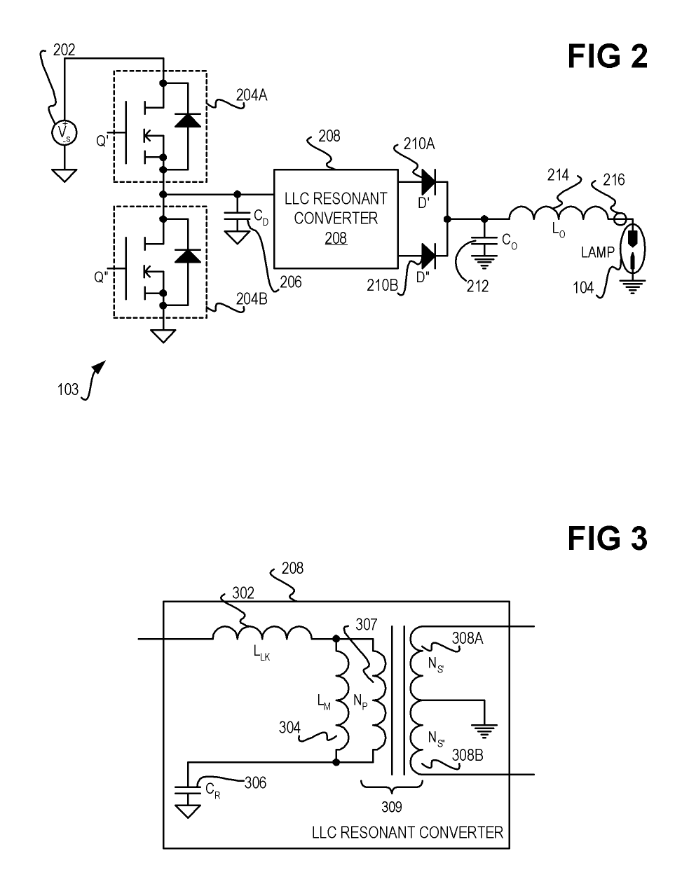

FIG. 2 shows the ballast 103 in detail, according to an embodiment of the invention. The ballast 103 converts and transmits power from a voltage (or power) source 202 to the HID lamp 104. The terms voltage source and power source are used synonymously herein. The voltage source 202 may be a 380-volt direct-current (DC) voltage source in one embodiment, and is connected to transistors 204A and 204B, collectively referred to as the transistors 204. The transistors 204, identified as transistors Q′ and Q″ in FIG. 2, are appropriately switched on and off to convert the DC voltage from the voltage source 202 into an alternating current (AC) voltage. The transistors 204 are more specifically switched in opposition at nearly full duty cycle, and the delay between the transistor 204A turning off and the transistor 204B turning on is adjusted to allow for zero-voltage switching operation. The transistors are more generally referred to as switching mechanisms.

An inductor-inductor-capacitor (LLC) resonant converter 208 is connected between the transistors 204. As such, the LLC resonant converter 208 is electrically coupled to the voltage source 202 via its connection between the transistors 204. A capacitor 206, identified as the capacitor CD in FIG. 2, is connected in parallel with the LLC resonant converter 208 between the transistors 204. The capacitor 206 provides a delay in the rise of the switching voltage to assist in the zero-voltage switching of the transistors 204. The LLC resonant converter 208 is particularly the component of the ballast 103 that converts and transmits the power from the voltage source 202 to the HID lamp 104, in that it converts the power provided by the voltage source 202, as switched by the transistors 204, to the voltage needed by the lamp 104 to ignite and then subsequently operate at steady state.

Two diodes 210A and 210B, collectively referred to as the diodes 210, and identified as diodes D′ and D″ in FIG. 2, rectify the voltage provided by the LLC resonant converter 208. This output voltage is transmitted to the lamp 104 via a capacitor 212 and an inductor 214, identified as the capacitor C₀ and the inductor L₀ in FIG. 2. In particular, the inductor 214 is connected between the diodes 210 and the lamp 104 to electrically couple the LLC resonant converter 208 to the HID lamp 104, whereas the capacitor is connected to the diodes 210 in parallel to a circuit branch encompassing the inductor 214 and the HID lamp 104. The capacitor 212 and the inductor 214 act as a filter to remove the switching frequency from the voltage provided by the LLC resonant converter 208 to the HID lamp 104.

A representative electrical connector 216 is depicted in FIG. 2, as to which the lamp 104 is connected. Thus, whereas components of the ballast 103 have been described in relation to FIG. 2 as pertaining to the HID lamp 104, these components also pertain to the electrical connector 216. The HID lamp 104 may be permanently or detachably connected to the electrical connector 216. The electrical connector 216 is said to be receptive to electrical coupling with the HID lamp 104.

FIG. 3 shows the LLC resonant converter 208 in detail, according to an embodiment of the invention. The LLC resonant converter 208 is particularly an “LLC” resonant converter in that it is made up of two inductors 302 and 304, identified as the inductors L_{LK} and L_{M} in FIG. 3, and one capacitor 306, identified as the capacitor C_{R}. The inductors 302 and 304 and the capacitor 306 are in series within one another. The inductors 302 and 304 are more generally inductive mechanisms, in that they may or may not be discrete components. For example, the inductor 302 in particular may be the inherent predesigned leakage inductance of a transformer 309 of the LLC resonant converter 208, such that it is not a discrete component. By comparison, the inductor 304 may be a discrete magnetizing inductor of the transformer 309.

The LLC resonant converter 208 varies in design from other types of resonant converters, at least because it is made up of two inductors 302 and 304 and one capacitor 306. By comparison, an LCC resonant converter is made up of a single inductor and two capacitors. Similarly, an LCLC resonant converter is made up of two inductors and two capacitors. Furthermore, the LLC resonant converter 208 specifies the order in which its components are connected. In particular, the first inductor 302 is connected in series to the second inductor 304, and the capacitor 306 is connected in series to the second inductor 304.

The LLC resonant converter 208 is a “resonant” converter in that it has at least one switching frequency of power input thereto (as switched by the transistors 204) at which the inductors 302 and/or 304 are in resonance with the capacitor 306. More particularly, the LLC resonant converter 208 is a multiple-mode resonant converter, or a multiply resonant converter, in that it has more than one, and specifically two, switching frequencies of power input thereto at which the inductors 302 and/or 304 are in resonance with the capacitor 306. In this latter instance in particular, the LLC resonant converter 208 is distinguished from other types of resonant converters that may only have one resonant frequency.

More specifically, the first resonant frequency of the LLC resonant converter 208 is the frequency at which the inductor 302 by itself is in resonance with the capacitor 306, such that the inductance of the inductor 302 alone (i.e., not including the inductor 304) in combination with the capacitance of the capacitor 306 controls the value of this frequency. This resonant frequency can be expressed mathematically as:

$${f}_{1} = \frac{1}{2 π \sqrt{{L}_{LK} {C}_{R}}} . \qquad ( 1 )$$

The first resonant frequency is that by which the needed voltage to the HID lamp 104 to ignite the HID lamp 104 is provided. This voltage can be lower than the operating voltage of the HID lamp 104 at which the HID lamp 104 operates after ignition and outputs a predetermined amount of light. Thus, the transistors 204 are switched at a switching frequency equal to the first resonant frequency when the HID lamp 104 is to be ignited.

The second resonant frequency of the LLC resonant converter 208 is the frequency at which the inductor 302 and the inductor 304 in combination are in resonance with the capacitor 306, such that the inductances of the inductor 302 and 304 in combination with the capacitance of the capacitor 306 control the value of this frequency. This resonant frequency can be expressed mathematically as:

$${f}_{2} = \frac{1}{2 π \sqrt{( {L}_{LK} + {L}_{M} ) {C}_{R}}} . \qquad ( 2 )$$

The second resonant frequency controls, or limits, the voltage provided to the HID lamp 104 prior to ignition of the lamp 104. That is, when the HID lamp 104 has not yet been ignited, the transistors 204 are switched at a switching frequency equal to the second resonant frequency so that the voltage provided to the HID lamp 104 is not too high.

Furthermore, operation at a switching frequency between the two resonant frequencies maintains a substantially constant output power being provided to the HID lamp 104 after the lamp 104 has been ignited, and substantially irrespective of the operating voltage of the HID lamp 104. As the HID lamp 104 ages, the operating voltage of the HID lamp 104 increases. The operating voltage of the HID lamp 104 is the voltage at which the lamp 104 operates after ignition and after it has warmed up, to output a substantially constant predetermined amount of light. That the operating voltage of the HID lamp 104 increases with age means that the output power provided to the HID lamp 104 has to be maintained substantially constant regardless of the operating voltage of the HID lamp 104, which increases over lamp life. Where the operating voltage is lower when the HID lamp 104 is new, more current has to be provided to maintain a given output power and for the lamp 104 to output the same predetermined amount of light, as compared to where the operating voltage is higher when the HID lamp 104 is old, in which case less current has to be provided to maintain this same output power.

Therefore, LLC resonant converter 208 is advantageous at least because it ensures that a substantially constant output power is provided to the HID lamp 104 throughout the lifetime of the lamp 104, as the operating voltage of the HID lamp 104 increases with age. In particular, the ratio between the inductance of the inductor 302 and the inductance of the inductor 304, as well as the overall impedance of the LLC resonant converter 208, can be selected to ensure substantially constant output power even over a substantially two-to-one range of operating voltage of the HID lamp 104. That is, even where the operating voltage of the HID lamp 104 when old (i.e., at end of life) is substantially twice that of the operating voltage of the lamp 104 when new(i.e., at beginning of life), the LLC resonant converter 208 can provide for substantially constant output power to the HID lamp 104.

Furthermore, the operating frequency can remain constant (between the first and the second resonant frequencies), or change minimally, for the LLC resonant converter 208 to provide substantially constant output power to the HID lamp 104 over the lifetime of the lamp 104, as the operating voltage of the HID lamp 104 increases with age. For example, the ballast 103 may provides 300 watts in output power to the HID lamp 104, from a 380-volt DC voltage source 202. It has been found in such instance that the operating frequency may have to change by just 4% to provide this constant output power where the HID lamp 104 has an operating voltage of 25 volts when old, as compared to where the lamp 104 has an operating voltage of 12 volts when new.

The power from the voltage source 202 as switched by the transistors 204 is thus regulated by the inductors 302 and 304 and the capacitor 306 based on the switching frequency of the transistors 204 in relation to the two resonant frequencies of the LLC resonant converter 208. The LLC resonant converter 208 also includes the transformer 309. The transformer 309 serves to transfer the electrical power from the voltage source 202, as switched by the transistors 204 and as regulated by the inductors 302 and 304 and the capacitor 306, ultimately to the lamp 104, as can be appreciated by those of ordinary skill within the art.

The transformer 309 has primary windings 307, identified in FIG. 3 as the windings N_{P}, on the input side, and two sets of secondary windings 308A and 308B, collectively referred to as the secondary windings 308 and identified in FIG. 3 as the windings N_{S′} and N_{S″}, on the output side. The primary windings 307 are electrically connected in series with the inductor 302 and in parallel with the inductor 304. The secondary windings 308 provide the output of the LLC resonant converter 208, and thus are ultimately electrically coupled to the HID lamp 104 via the electrical connector 216. There is further a connection to ground between the secondary windings 308, as depicted in FIG. 3.

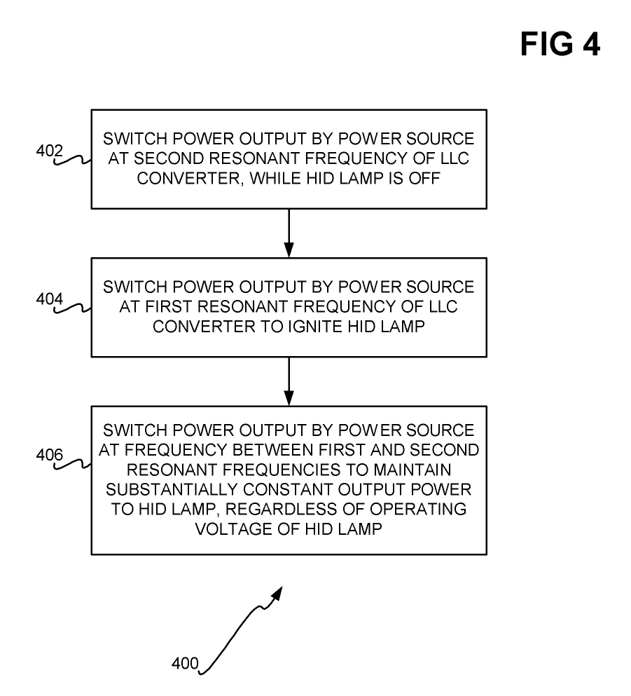

FIG. 4 shows a method 400 for operating the ballast 103 having the LLC resonant converter 208, according to an embodiment of the invention. The method 400 may be performed by the controller 112 of FIG. 1, for instance. The method 400 may further be implemented as a computer program stored on a tangible computer-readable medium.

The power output by the voltage source 202 is switched at a frequency equal to the second resonant frequency of the LLC converter 208 that has been described (402), while the HID lamp 104 is off and thus before the HID lamp 104 has been ignited. Such switching can be achieved, for instance, by the transistors 204. In one embodiment, the output voltage provided to the HID lamp 104 in part 402 is equal to the operating voltage of the HID lamp 104, which is higher than the ignition voltage at which the HID lamp 104 is ignited. Switching the power at the second resonant frequency limits the voltage provided to the HID lamp 104 while the HID lamp 104 remains unignited.

Thereafter, when ignition of the HID lamp 104 is desired to output light from the HID lamp 104, the power output by the voltage source 202 is switched at a frequency equal to the first resonant frequency of the LLC converter 208 that has been described (404). As a result, the HID lamp 104 is ignited. In one embodiment, the output voltage provided to the HID lamp 104 in part 404 is equal to the ignition voltage at which the HID lamp 104 is ignited, which is lower than the operating voltage of the HID lamp 104 at which the HID lamp 104 normally operates.

Finally, after the HID lamp 104 has been ignited, the power output by the voltage source 202 is switched at a frequency between the two resonant frequencies of the LLC converter 208 (406), as has been described. As a result, substantially constant output power is provided to the HID lamp 104, regardless of the operating voltage of the HID lamp 104. As has been noted, the operating voltage of the HID lamp 104 increases with age. That is, the operating voltage of the HID lamp 104 needed to output the same predetermined amount of light increases with age.

I claim:

1. A ballast for a projector high-intensity discharge (HID) lamp, comprising:
an electrical connector receptive to electrical coupling with the projector HID lamp; and,
an inductor-inductor-capacitor (LLC) resonant converter to convert and transmit power received from a power source to the projector HID lamp via the electrical connector.

2. The ballast of claim 1, wherein the LLC resonant converter comprises:
a first inductive mechanism;
a second inductive mechanism in series with the first inductive mechanism; and,
a capacitive mechanism in series with the first and the second inductive mechanisms.

3. The ballast of claim 2, wherein at least an inductance of the first inductive mechanism and an inductance of the second inductive mechanism are selected so that substantially constant power is provided to the projector HID lamp over a lifetime of the projector HID lamp, where an operating voltage of the projector HID lamp increases with age, the operating voltage of the projector HID lamp being that at which the projector HID lamp operates after ignition and outputs a predetermined amount of light.

4. The ballast of claim 3, wherein a ratio of the operating voltage of the projector HID lamp at end-of-life to the operating voltage of the projector HID lamp at beginning-of-life being substantially 2:1.

5. The ballast of claim 2, further comprising a transformer having a plurality of primary windings and a plurality of secondary windings, the primary windings electrically connected in series with the first inductive mechanism and the capacitive mechanism and in parallel with the second inductive mechanism, the secondary windings electrically coupled to the electrical connector.

6. The ballast of claim 2, wherein the first inductive mechanism is implicit within a transformer of the LLC resonant converter, such an inductance of the first inductive mechanism is a predesigned inductance of the transformer.

7. The ballast of claim 2, wherein the second inductive mechanism is a discrete inductor and the capacitive mechanism is a discrete capacitor.

8. The ballast of claim 1, wherein the LLC resonant converter has a plurality of resonant frequencies comprising:
a first resonant frequency at which the projector HID lamp is ignited at an ignition voltage lower than an operating voltage of the projector HID lamp at which the projector HID lamp operates after ignition and outputs a predetermined amount of light; and,
a second resonant frequency at which the projector HID lamp has already been ignited or has not yet been ignited, to limit a voltage provided to the projector HID lamp prior to ignition,
wherein an operating frequency between the first and the second resonant frequencies results in maintaining a substantially constant output power provided to the projector HID lamp as the operating voltage of the projector HID lamp increases with age.

9. The ballast of claim 8, wherein the LLC resonant converter comprises a first inductive mechanism, a second inductive mechanism, and a capacitive mechanism, an inductance of the first inductive mechanism and a capacitance of the capacitive mechanism controlling the first resonant frequency of the LLC resonant converter, and the inductance of the first inductive mechanism, an inductance of the second inductive mechanism, and the capacitance of the capacitive mechanism controlling the second resonant frequency of the LLC resonant converter.

10. The ballast of claim 1, further comprising a pair of switching mechanisms to which the power source is connected, the LLC resonant converter electrically coupled to the power source via connection between the switching mechanisms.

11. The ballast of claim 10, further comprising a capacitor connected in parallel with the LLC resonant converter between the switching mechanisms.

12. The ballast of claim 1, further comprising:
a plurality of diodes connected to the LLC resonant converter;
an inductor connected between the diodes and the electrical connector to electrically couple the LLC resonant converter to the electrical connector; and,
a capacitor connected between the diodes, in parallel to a circuit branch encompassing the inductor and the electrical connector.

13. The ballast of claim 1, wherein the projector HID lamp is detachably connectable to the electrical connector, such that the ballast is a separate component from the projector HID lamp.

14. The ballast of claim 1, wherein the projector HID lamp is permanently connected to the electrical connector, such that the ballast and the projector HID lamp constitute an integrated ballast-lamp assembly for detachable connection within a projector.

15. A projector comprising:
a projector high-intensity discharge (HID) lamp to output light;
a ballast having an inductor-inductor-capacitor (LLC) resonant converter to convert and transmit power received from a power source to the projector HID lamp; and,
an image-display component to modulate the light in accordance with image data to be displayed by the projector.

16. The projector of claim 15, wherein the LLC resonant converter comprises:
a first inductive mechanism;
a second inductive mechanism in series with the first inductive mechanism; and,
a capacitive mechanism in series with the first and the second inductive mechanisms.

17. The projector of claim 16, wherein at least an inductance of the first inductive mechanism and an inductance of the second inductive mechanism are selected so that substantially constant power is provided to the projector HID lamp over a lifetime of the projector HID lamp, where an operating voltage of the projector HID lamp increases with age, the operating voltage of the projector HID lamp being that at which the projector HID lamp operates after ignition and outputs a predetermined amount of light.

18. The projector of claim 16, wherein the LLC resonant converter has a plurality of resonant frequencies comprising:
a first resonant frequency at which the projector HID lamp is ignited at an ignition voltage lower than an operating voltage of the projector HID lamp at which the projector HID lamp operates after ignition and operates a predetermined amount of light; and,
a second resonant frequency at which the projector HID lamp has already been ignited or has not yet been ignited, to limit a voltage provided to the projector HID lamp prior to ignition,
wherein an operating frequency between the first and the second resonant frequencies results in maintaining a substantially constant output power provided to the projector HID lamp as the operating voltage of the projector HID lamp increases with age, and
wherein an inductance of the first inductive mechanism and a capacitance of the capacitive mechanism controls the first resonant frequency of the LLC resonant converter, and the inductance of the first inductive mechanism, an inductance of the second inductive mechanism, and the capacitance of the capacitive mechanism controls the second resonant frequency of the LLC resonant converter.

19. A method comprising:
switching power output by a power source at a frequency equal to a second resonant frequency of an inductor-inductor-capacitor (LLC) resonant converter converting and transmitting the power from the power source to a projector high-intensity discharge (HID) lamp, before the projector HID lamp has been ignited;
switching the power output by the power source at a frequency equal to a first resonant frequency of the LLC resonant converter to ignite the projector HID lamp such that the projector HID lamp outputs light; and,
switching the power output by the power source at a frequency between the first and the second resonant frequencies of the LLC resonant converter to maintain a substantially constant output power provided to the projector HID lamp as the operating voltage of the projector HID lamp increases with age so that the projector HID lamp outputs a same predetermined amount of light.

20. The method of claim 19, wherein the LLC resonant converter comprises a first inductive mechanism, a second inductive mechanism, and a capacitive mechanism, an inductance of the first inductive mechanism and a capacitance of the capacitive mechanism controlling the first resonant frequency of the LLC resonant converter, and the inductance of the first inductive mechanism, an inductance of the second inductive mechanism, and the capacitance of the capacitive mechanism controlling the second resonant frequency of the LLC resonant converter.
